(19) United States
(12) Patent Application Publication
(10) Pub. No.: US 2009/0212562 A1
(43) Pub. Date: Aug. 27, 2009

(54) METHOD AND APPARATUS FOR TIDAL POWER GENERATION

(75) Inventor: John M. Jaugilas, Aurora, CO (US)

Correspondence Address: THE BOEING COMPANY;c/o FELIX L. FISCHER, ATTORNEY AT LAW, 1607 MISSION DRIVE, SUITE 204, SOLVANG, CA, 93463, US

(73) Assignee: THE BOEING COMPANY, Chicago, IL (US)

(21) Appl. No.: 12/038,293

(22) Filed: Feb. 27, 2008

(51) Int. Cl. F03B 13/26

(52) U.S. Cl. 290/42; 290/53

(57) ABSTRACT

A tidal power generation system incorporates a buoy tethered to a first cable with a power generation spool engaging the first cable for rotational motion upon extraction of the cable by the buoy during elevation increases of the water on which the buoy is riding. An electrical generator is connected to the power generation spool and a rewinder for the power generation spool reels in the cable during receding water elevation. A gear drive interconnects the power generation spool and electrical generator with a gear reduction in certain embodiments for increasing generator rotational speed. The rewinder uses a rewind spool connected to the power generation spool and engaging a second cable for counter-rotational motion. A mechanical energy storage device is connected to the second cable. A suspended weight provides energy storage in the first embodiment while a spring attached to a fixed anchor point provides energy storage in an alternative embodiment.

### BACKGROUND OF THE INVENTION

1. Field of the Invention

Embodiments of the disclosure relate generally to the field of conversion of tide motion to electrical power and more particularly to a method and apparatus for employing rising tide forces exerted on a buoy extendibly tethered for rotational actuation of a gear drive connected to an electrical generator.

2. Description of the Related Art

There is a pressing need to develop clean energy sources. Since most of the surface of the earth is covered by water, water based systems provide the most potential for energy generation due to sheer volume. The gravitational effect that causes tides provides an enormous amount of energy since the mass and force of the water is many times greater than that of any air based system. Moving even just a few thousand cubic feet of water requires energy that would take up incredible amounts of airspace or physical land to be equaled with either wind or solar power. Therefore the tides provide the largest amount of renewable energy to be harnessed by orders of magnitude over other renewable energy forms.

The Bay of Fundy, as exemplary of the natural tidal systems available, has tidal variation of 40 feet. The energy in moving that mass of water every day is absolutely enormous. This is a naturally occurring geographic phenomenon that may be duplicated in man made tidal zones.

Present emphasis for water based energy production focuses on water turbines, which are analogous to propellers, affixed to electrical generators. The potential negative effects of these devices is already known from what happens to fish that are expelled through existing systems in hydro-electric dams. Use of these types of devices in the sea to capture the ocean current will produce the same negative effects. While the aquatic life will not be force fed through the blades as in the case of a dam turbine, they will be exposed to the operation of the blades and potentially be carried through the blade disk. This will result in injuries or deaths in marine life inhabiting the vicinity of such energy generation systems and may result in costly blade damage.

In some countries tidal water flow is directed into a dam like structure and power is created by duplicating a hydroelectric dam where the tide simply fills the reservoir structure. This creates an unsightly and large un-desirable structure that mars the scenic beauty of a coastline. In addition to the visual environmental impact this system has all of the inherent inefficiencies of a hydroelectric dam structure, and is only useable near shorelines whereas the invention can be used even in deep water locations.

It is therefore desirable to provide a system which achieves a power generation without exposed rotational devices which may interact negatively with the marine habitat.

It is further desirable to provide a system employs tidal motion for power generation in a simple and reliable structure.

### SUMMARY OF THE INVENTION

Exemplary embodiments of a tidal power generation system incorporate a buoy tethered to a first cable with a power generation spool engaging the first cable for rotational motion upon extraction of the cable by the buoy during elevation increases of the water on which the buoy is riding. An electrical generator is connected to the power generation spool and a rewinder for the power generation spool reels in the cable during receding water elevation. A gear drive interconnects the power generation spool and electrical generator with a gear reduction in certain embodiments for increasing generator rotational speed.

In a first embodiment, the rewinder uses a rewind spool connected to the power generation spool and engaging a second cable for counter-rotational motion. A mechanical energy storage device is connected to the second cable. A suspended weight provides energy storage in the first embodiment while a spring attached to a fixed anchor point provides the energy storage in an alternative embodiment.

The embodiments provide a buoy riding on the ocean surface and connected to a first cable extractable from a first spool inducing rotation for energy collection. The first cable is extracted from the first spool using upward motion of the buoy during water level increases imparting rotational motion to a generator. Simultaneously a second spool coaxial with the first spool and engaged for common rotation rewinds a second cable attached to a mechanical energy storage system. Electrical energy created by the generator is transmitted to an electrical grid or stored. The second cable is extracted from the rewind spool using conversion of the energy stored in the mechanical energy storage system causing counter-rotational motion in both spools to rewind the first cable when receding water level lowers the buoy causing tension on the first cable to be reduced.

### BRIEF DESCRIPTION OF THE DRAWINGS

The features and advantages of embodiments disclosed herein will be better understood by reference to the following detailed description when considered in connection with the accompanying drawings wherein:

FIG. 1a is a detailed side elevation view of a first embodiment demonstrating the axial arrangement of the cable spool, rewind spool and mechanical engagement system for the generator;

FIG. 1b is an expanded view of the embodiment of FIG. 1a showing a mechanical energy storage device;

FIG. 2 is a top view of a second embodiment employing an alternative mechanical force storage mechanism;

FIG. 3 is a flow chart of the method employing the physical embodiments shown herein for unidirectional power generation;

FIG. 4 is a flow chart of an alternative method for bidirectional power generation; and,

FIG. 5 is a side view of an additional alternative embodiment for surface mounting of the generator system.

### DETAILED DESCRIPTION OF THE INVENTION

The embodiment disclosed herein combines a simple floating mass such as a buoy with a generator to generate electricity through conversion of the energy required to raise the buoy during every wave or tidal cycle. In choppy waters a buoy is constantly bobbing up and down. This motion and the longer mode tidal rise are both energy sources that can be converted into electrical power. Currently buoys are secured to the ocean floor at a fixed point.

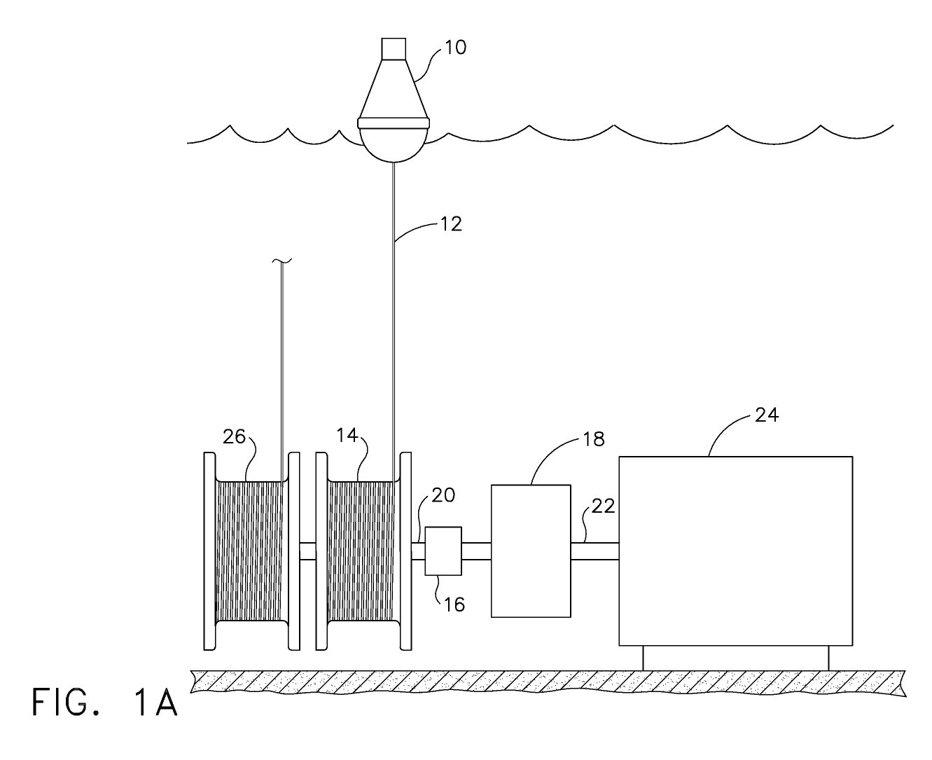

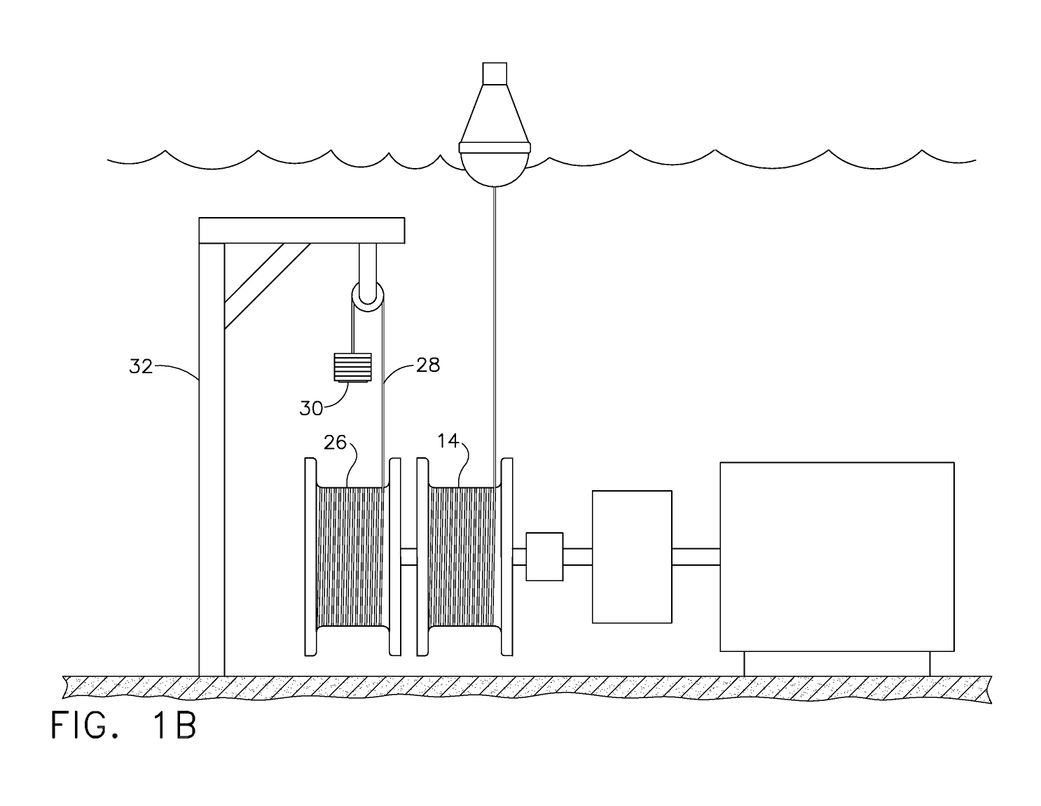

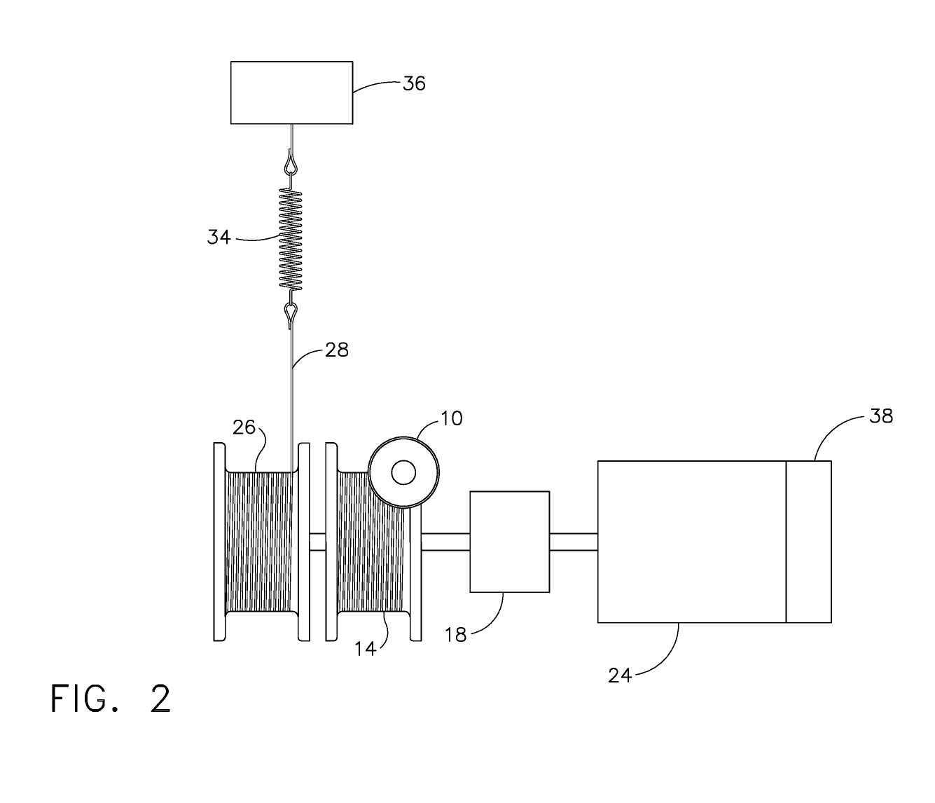

As shown in FIG. 1A a buoy 10 is secured with a cable 12 which may be substantially the same length as that necessary to allow the required motion of a conventionally moored buoy. The cable is attached to a first power generation spool 14 that is attached through a unidirectional bearing 16 to a gear drive 18. A first shaft 20 is connected intermediate the power generation spool and the unidirectional bearing and the gear drive engages an input shaft 22 for a generator 24. For an initial exemplary embodiment, a rewind spool 26 contains a light cable 28 attached to a mechanical force storage mechanism, such as a weight 30 supported by a suspension structure 32, that counter-rotates the spools to reel in the cable attached to the buoy when tension is reduced or slack is present as the tide ebbs or during downward portions of wave cycles as shown in FIG. 1B. In alternative embodiments, a spring 34 as described with respect to FIG. 2 is employed as the mechanical force storage mechanism.

The directional bearing of the first embodiment allows the spools to run free during the slack rewind mode. A gear reduction system in gear drive 18 intermediate the directional bearing and the generator input shaft causes the motion of the rising buoy to spin the generator at many times the rotation rate of the spool, enabling an efficient power generation speed for the generator. The effective gear ratio provided is predetermined to optimize efficiency of the generator system and may range from 1:10 to as much as 1:1000 or more. The ratio employed is determined based on the anticipated primary generation mode; wave action or tidal action with a higher ratio used for tidal action and a lower ratio for wave action. In this way any time the buoy is moved upward by the force of the tide or waves that upward force is converted into electrical power. As the tide or waves lower, the spring or gravity spool re-winds the power generation cable.

For the embodiment shown with mechanical and electrical components submerged on the ocean floor, all components are sealed for underwater use.

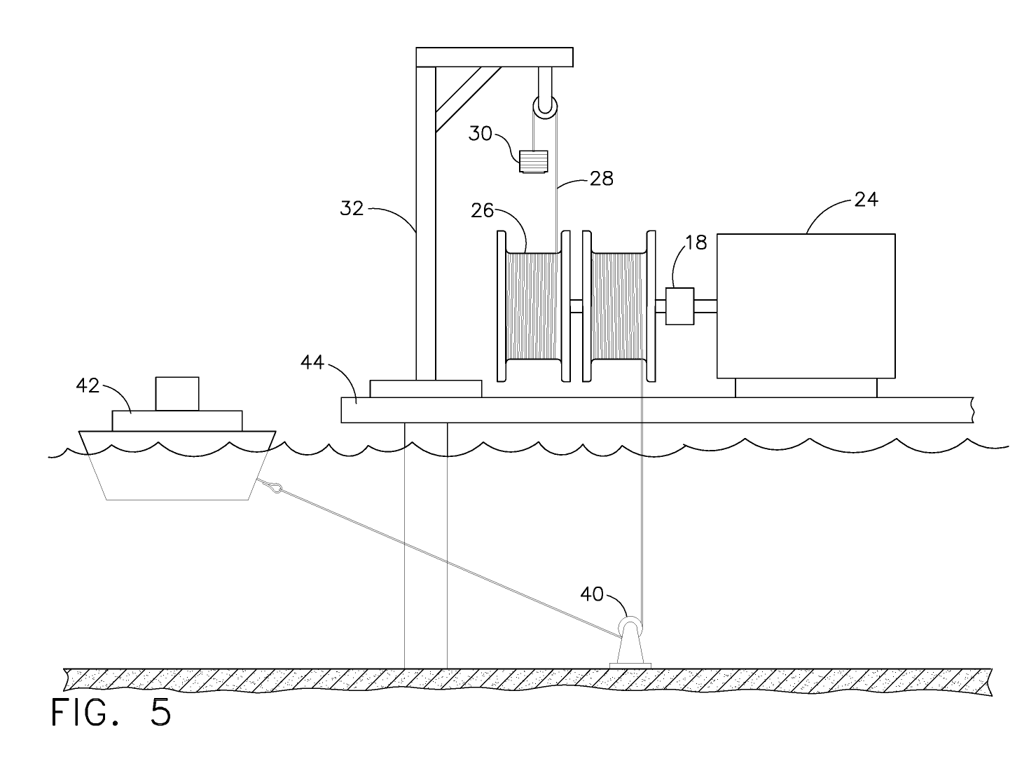

In the initial embodiments disclosed herein conventional buoys are used and the generator is underwater to minimize visual impact to the environment. In alternative embodiments, an additional pulley system 40 allows the generator/alternator to be mounted above water as shown in FIG. 5. In other alternative embodiments the buoy may be replaced by an empty ship hull 42, or a stationary floating structure such as a riverboat casino, floating bridges or floating docks. In an example of such an embodiment the cable system attaches to boats that are docked with pulleys to the generator on the adjacent stationary dock 44. As the boats move up and down next to the dock the generator would be activated.

In the alternative embodiment shown in FIG. 2, spring 34 is attached to a fixed anchor point 36 and rewind cable 28 engaging the rewind spool. The generator for the alternative embodiment employs a rectifier system 38 for bidirectional electrical generation allowing the unidirectional bearing of the first embodiment to be eliminated. The rectifier system employs filtering for transient control and power regulation for interfacing with power storage and transmission systems from the generator which are not shown for the embodiments herein but would employ standard techniques known to those in the art. While a generator is shown and described for the embodiments disclosed an appropriate alternator for electrical current generation is employed in alternative embodiments.

The embodiments disclosed herein may additionally be employed in groups as a “farm” with associated generators collectively feeding power to a storage or transmission system. Such farms may be employed by grouping of systems in a deep water location or a plurality of “stations” each employing the elements of the embodiments disclosed herein may be provided at a port for each large ship berth.

Additional benefits of the embodiments disclosed are also achieved through construction of the floating mass using a high displacement, low density material such as Expanded Poly Propylene foam with a fiberglass shell or other sealing means with suitable internal members for structural integrity imposed by the buoyant force and power generation cable. Low mass additionally provides that either wave or tidal action can be effectively harnessed for energy generation. Potential damage to ships or even whales that might encounter a buoy farm is also minimized with such a structure. The force that is harnessed by the embodiments herein is buoyant force so a primary performance factor is water displacement.

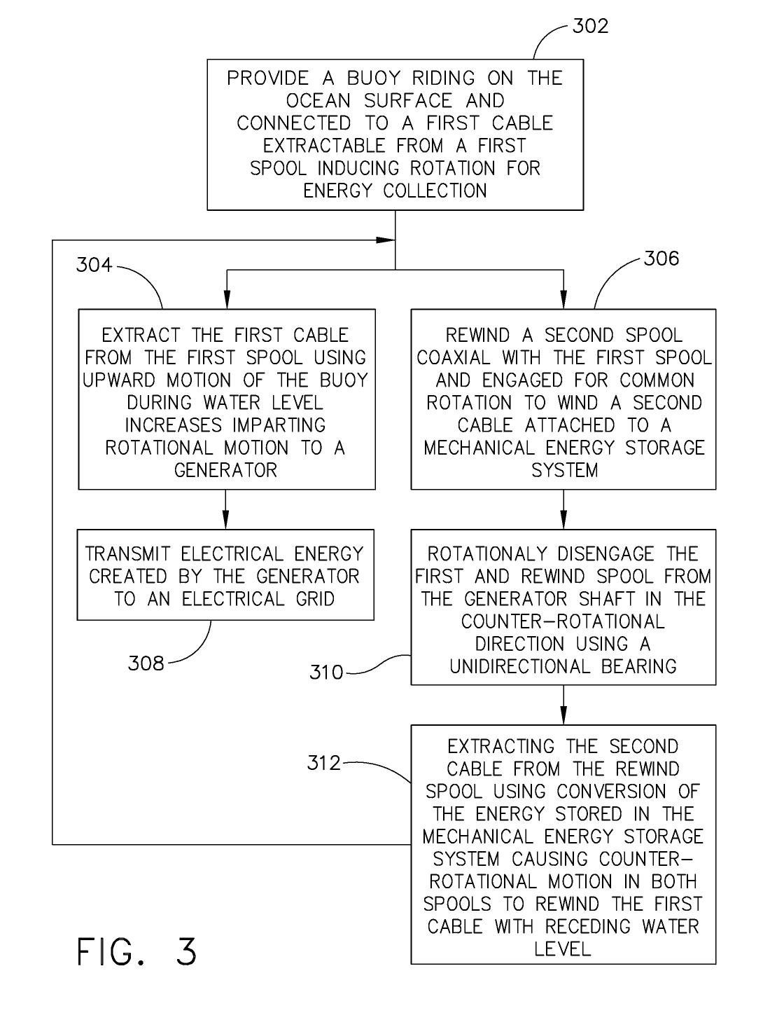

In operation the system employs the buoy riding on the ocean surface for energy collection as reflected in step 302 of FIG. 3. A rising level of the water, whether due to wave action or tidal flow, extracts a first cable from a first spool imparting rotational motion to a generator, step 304. Simultaneously a rewind spool coaxial with the first spool and engaged for common rotation winds a second cable attached to a mechanical energy storage system, step 306. Electrical energy created by the generator is transmitted or stored for use by an electrical grid, step 308. A receding water level lowers the buoy causing tension on the first cable to be reduced and conversion of the energy stored in the mechanical energy storage system is used to extract the second cable from the rewind spool causing counter-rotational motion in both spools rewinding the first cable, step 312.

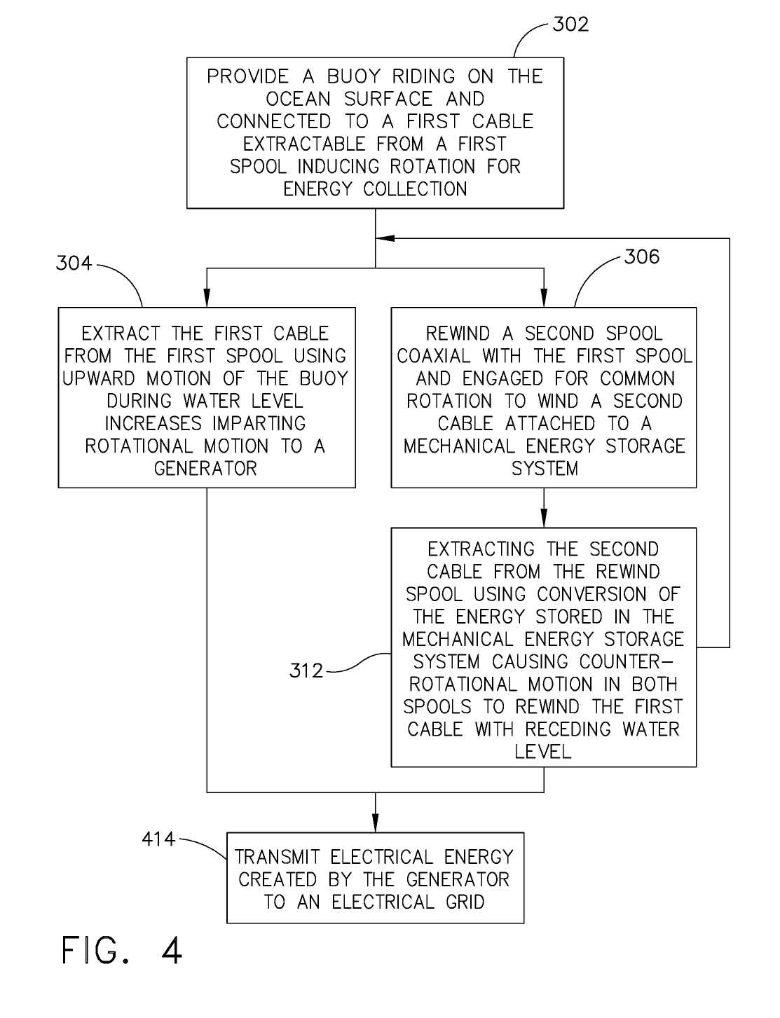

In the first embodiment with a unidirectional generator, the use of the unidirectional bearing provides a rotational disengagement of the first and rewind spool from the generator shaft in the counter-rotational direction, step 310. Alternatively as shown in FIG. 4, use of a bi-directional generator or alternator system provides electrical energy created by the generator in the counter-rotational direction to be transmitted or stored for use by the grid, step 414.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A tidal power generation system comprising:
a floating mass tethered to a first cable;
a power generation spool engaging the first cable for rotational motion upon extraction of the cable by the floating mass during increasing elevation of water on which the floating mass is riding;
an electrical generator connected to the power generation spool; and,
means for rewinding the power generation spool when the water elevation is receding.

2. The tidal power generation system of claim 1 further comprising a gear drive interconnecting the power generation spool and electrical generator.

3. The tidal power generation system of claim 1 wherein the rewinding means comprises:
a rewind spool connected to the power generation spool and engaging a second cable for counter-rotational motion;
a means for mechanical energy storage connected to the second cable.

4. The tidal power generation system of claim 3 wherein the means for mechanical energy storage comprises:
a weight connected to the second cable and
means for suspending the weight.

5. The tidal power generation system of claim 3 wherein the means for mechanical energy storage comprises a spring connected between the second cable and an anchor point.

6. The tidal power generation system of claim 1 further comprising a unidirectional bearing intermediate the power generation spool and the gear drive.

7. The tidal power generation system of claim 1 wherein the gear drive includes a gear reduction system.

8. The tidal power generation system of claim 1 wherein the floating mass is a buoy.

9. The tidal power generation system of claim 1 wherein the floating mass is a ship.

10. A method for tidal power generation comprising the steps of:
providing a buoy riding on the ocean surface and connected to a first cable extractable from a first spool inducing rotation for energy collection;
extracting the first cable from the first spool using upward motion of the buoy during water level increases imparting rotational motion to a generator;
simultaneously rewinding a second spool coaxial with the first spool and engaged for common rotation to wind a second cable attached to a mechanical energy storage system;
transmitting electrical energy created by the generator to an electrical grid; and,
extracting the second cable from the rewind spool using conversion of the energy stored in the mechanical energy storage system causing counter-rotational motion in both spools to rewind the first cable when receding water level lowers the buoy causing tension on the first cable to be reduced.

11. The method of claim 10 further comprising the step of:
using a unidirectional bearing to provide a rotational disengagement of the first and rewind spool from the generator shaft in the counter-rotational direction.

12. The method of claim 10 further comprising the step of:
using a bidirectional generator system to provide electrical energy created by the generator in the counter-rotational direction to be transmitted or stored for use by the grid.

13. A power generator system comprising:
a generator located proximate to a land surface under a body of water,
a buoy attached to the generator through a mechanical linkage and floating on the water surface, such that as the buoy moves vertically, the mechanical linkage turns the generator thereby producing an electric current.

14. The power generator system of claim 13 wherein the generator is in electrical communication with a power grid.

15. The power generator system of claim 13 wherein the mechanical linkage comprises:
a first cable;
a power generation spool engaging the first cable for rotational motion upon extraction of the cable by the buoy during increasing elevation of water on which the buoy is riding; and,
means for rewinding the power generation spool when the water elevation is receding; and,
wherein the electrical generator is connected to the power generation spool.

16. The power generator system of claim 13 wherein said buoy is constructed of a high displacement, low density material.

17. The power generator system of claim 16 wherein the high displacement, low density material is Expanded Poly Propylene foam with a fiberglass shell.

18. A method of producing electricity comprising:
positioning a floating mass in a body of water such that a change in water level moves the floating mass; and
attaching the floating mass to turn a generator located at a position proximate the floating mass during such motion.

19. The method of claim 18 wherein the step of attaching the floating mass comprises the steps of:
connecting a first cable extractable from a first spool inducing rotation of the generator;
extracting the first cable from the first spool using upward motion of the floating mass during water level increases imparting said rotational motion to the generator.

20. The method of claim 19 further comprising the steps of:
simultaneously rewinding a second spool coaxial with the first spool and engaged for common rotation to wind a second cable attached to a mechanical energy storage system;
transmitting electrical energy created by the generator to an electrical grid; and,
extracting the second cable from the rewind spool using conversion of the energy stored in the mechanical energy storage system causing counter-rotational motion in both spools to rewind the first cable when receding water level lowers the buoy causing tension on the first cable to be reduced.

21. The method of claim 18 wherein the floating mass is a buoy.

22. The method of claim 18 wherein the floating mass is a moored boat.

23. The method of claim 20 further comprising the step of interconnecting a plurality of generators driven by a plurality of floating masses to transmit energy to the grid.
